(19) United States
(12) Patent Application Publication
(10) Pub. No.: US 2017/0256197 A1
(43) Pub. Date: Sep. 7, 2017

(54) Systems and Methods for Providing Input to a Computer-Mediated Reality Device Using a Viewing Device

(71) Applicant: Disney Enterprises, Inc., Burbank, CA (US)

(72) Inventors: Michael P. Goslin, Sherman Oaks, CA (US); Joseph Logan Olson, Pasadena, CA (US)

(73) Assignee: DISNEY ENTERPRISES INC.

(21) Appl. No.: 15/402,113

(22) Filed: Jan. 9, 2017

Related U.S. Application Data
(60) Provisional application No. 62/302,707, filed on Mar. 2, 2016.

(51) Int. Cl. G09G 3/20; G02B 27/01; G09G 3/02; G02B 27/02; G06T 19/00; G06F 3/041

(52) U.S. Cl. CPC G09G 3/2096; G06T 19/006; G06F 3/041; G09G 3/025; G02B 27/022; G02B 27/0101; G09G 2320/0606; G09G 2320/0626; G09G 2354/00; G06F 3/0362

(57) ABSTRACT

There is provided system including a user device and a viewing device configured to receive the user device, the viewing device including a control element and a viewing portal, the user device including a display, a non-transitory memory storing an executable code, a hardware processor executing the executable code to display, on the display, a computer-mediated reality content visible by a user through the viewing portal of the viewing device, receive a first input from the viewing device, in response to a second input provided by the user using the control element of the viewing device, modify an operational element of the user device, in response to the first input.

### RELATED APPLICATION(S)

The present application claims the benefit of and priority to a U.S. Provisional Patent Application Ser. No. 62/302,707, filed Mar. 2, 2016, which is hereby incorporated by reference in its entirety into the present application.

### BACKGROUND

Recent advances in technology have brought about a plethora of computer-mediated reality devices, including virtual reality headsets and augmented reality devices ranging from handheld devices to wearable devices, such as glasses. Many of these computer-mediated reality devices augment reality by adding a visual component superimposed over the real-world scene viewed by the user on the screen of the device. Adjusting settings of these conventional devices requires input from the user directly to the device.

### SUMMARY

The present disclosure is directed to systems and methods for providing input to a computer-mediated reality device using a viewing device, substantially as shown in and/or described in connection with at least one of the figures, as set forth more completely in the claims

### BRIEF DESCRIPTION OF THE DRAWINGS

FIG. 1 illustrates a diagram of an exemplary system including a computer-mediated reality device and a viewing device, according to one implementation of the present disclosure;

FIG. 2 illustrates a viewing side of a headset including an exemplary viewing device of the system of FIG. 1 with an exemplary computer-mediated reality device of the system of FIG. 1 plugged into the headset, according to one implementation of the present disclosure;

FIG. 3 illustrates a side view of the viewing device of FIG. 2 with the computer-mediated reality device plugged therein, according to one implementation of the present disclosure;

FIG. 4 illustrates a front view of the viewing device of FIG. 2, according to one implementation of the present disclosure;

FIG. 5a illustrates an exemplary real-world scene presented by the viewing device of FIG. 2, according to one implementation of the present disclosure;

FIG. 5b illustrates an exemplary augmented-reality scene presented by the viewing device of FIG. 2 using the computer-mediated reality device, according to one implementation of the present disclosure;

FIG. 6 illustrates a flowchart illustrating an exemplary method of providing input to the computer-mediated reality device via the viewing device of FIG. 2, according to one implementation of the present disclosure.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

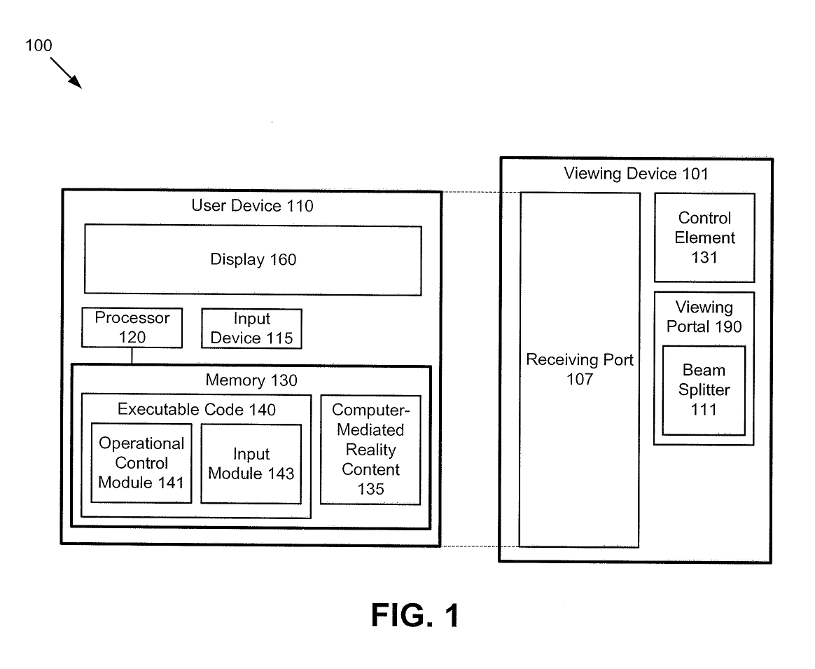

FIG. 1 illustrates a diagram of an exemplary system including a computer-mediated reality device and a viewing device, according to one implementation of the present disclosure. System 100 includes viewing device 101 and a computer-mediated reality device or user device 110. As shown in FIG. 1, viewing device 101 includes receiving port 107 for receiving user device 110, control element 131 and viewing portal 190. Viewing device 101 includes receiving port 107, control element 131, and viewing port 190. Viewing device 101 may be a headset, such as a virtual reality headset, or may be a hand-held device or head mounted device, such as a device held on the head of a user using a helmet, straps, or other securing device. Receiving port 107 may be a port configured to receive user device 110, such as a mobile phone or mini tablet. In some implementations, receiving port 107 may be configured to receive and plugging in user device 110. Receiving port 107 may be positioned such that user device 110 is held in a position that is substantially parallel to, and does not obstruct, the line of sight of a user looking through viewing portal 190, such as below the line of sight of the user, above the line of sight of the user, to a side of the line of sight of the user, etc.

Control element 131 may be a device for activation or operation by a user. In some implementations, a user may provide an input by operating control element 131. Control element 131 may be a switch, a knob, a slider, a button, a click-wheel, etc. Operation of control element 131 by the user may provide an input for user device 110. Control element 131 may be used to create an audible sound, such as a click, that may be used as input to user device 110. In other implementations, control element 131 may operate to provide a visual input, such as a color, a shade of gray, a pattern, etc., to user device 110. Control element 131 may be incorporated into another element of viewing device 101, such as an adjustable lens. Operation of control element 131 may result in a unique motion of viewing device 101 to provide motion input to user device 110.

Viewing portal 190 may be a portal allowing a user to see into viewing device 101 and may be a monocular viewing portal or a binocular viewing portal. In some implementations, viewing portal 190 may pass through viewing device 101, allowing the user to view the real world through viewing device 101. Viewing portal 190 may have a user side opening and a real-world side opening, such that the user side opening is the side opening through which a user looks into viewing portal 190 and the real-world side opening is the side at the opposite end of viewing portal 190 that looks out to the real world. Viewing portal 190 may include beam splitter 111. Beam splitter 111 may be an optical device that can split an incident light beam into two or more transmission beams. In some implementations, one of the transmission beams may be a viewing beam that is transmitted to viewing portal 190 for viewing by the user of viewing device 101. The incident light be may be transmitted by user device 110. Beam splitter 111 may superimpose a display content shown by user device 110 on a real-world view of a user looking through viewing portal 190.

User device 110 includes input device 150, processor 120, memory 130, and display 160. User device may be a mobile device, such as a mobile phone, a tablet computer, or other mobile personal computing device. Input device 115 may be an element of user device 110 used for receiving input, such as a microphone, a camera, a touch screen, an accelerometer, etc. Input device 115 may receive input from a user, input resulting from a user interacting with viewing device 101, such as by operating control element 131. The user may operate control element 131 to provide an audio input to a microphone, to rotate a knob to provide different visual inputs to a camera, such as a color, a shade of gray, a pattern, etc. cause a touch on the touch screen, or cause a movement of user device 110 for detection by the accelerometer.

Processor 120 is a hardware processor, such as a central processing unit (CPU), used in user device 110. Memory 130 is a non-transitory storage device for storing computer code for execution by processor 120, and also for storing various data and parameters. Memory 130 includes computer-mediated reality content 135 and executable code 140. Computer-mediated reality content 135 may be a media content, such as a graphic content, a data content, a video content, etc. Computer-mediated reality content 135 may include an augmented reality content, where computer-mediated reality content is viewed in combination with the real world, such as when an augmented reality content is superimposed over a real world image or a real world view. Computer-mediated reality content 135 may include a virtual reality content, where processor 120 renders a virtual reality, real or imagined, and simulates a user's physical presence and environment in the virtual reality in a way that may allow the user to interact with the virtual reality environment. In some implementations, the virtual reality may be a virtual representation of the real world, or the virtual reality may be a virtual world. Computer-mediated reality content 135 may include a content that falls on the mixed reality spectrum.

Executable code 140 includes one or more software modules for execution by processor 120 of user device 110. As shown in FIG. 1, executable code 140 includes operational control module 141 and input module 143. Operational control module 141 is a software module stored in memory 130 for execution by processor 120 to modify one or more operational elements of user device 110. In some implementations, operational control module 141 may adjust the brightness of a content displayed on display 190, such as computer mediated reality content 135.

Input module 143 is a software module stored in memory 130 for execution by processor 120. In some implementations, input module 143 may receive an input from input device 115 based on a user interaction with viewing device 101. For example, the user may operate control element 131 to provide audio input, visual input, motion input, etc., to user device 110, and input device 115 may receive the audio, visual, and/or motion input. In response to the input, input module 143 may switch user device 110 from one mode to another. For example, the user may be viewing an augmented reality content through viewing portal 190 and operate control element 131 to block the real-world view, and in the process provide input to input device 115. In response to the input, input module 143 may switch user device from an augmented reality mode to a virtual reality mode.

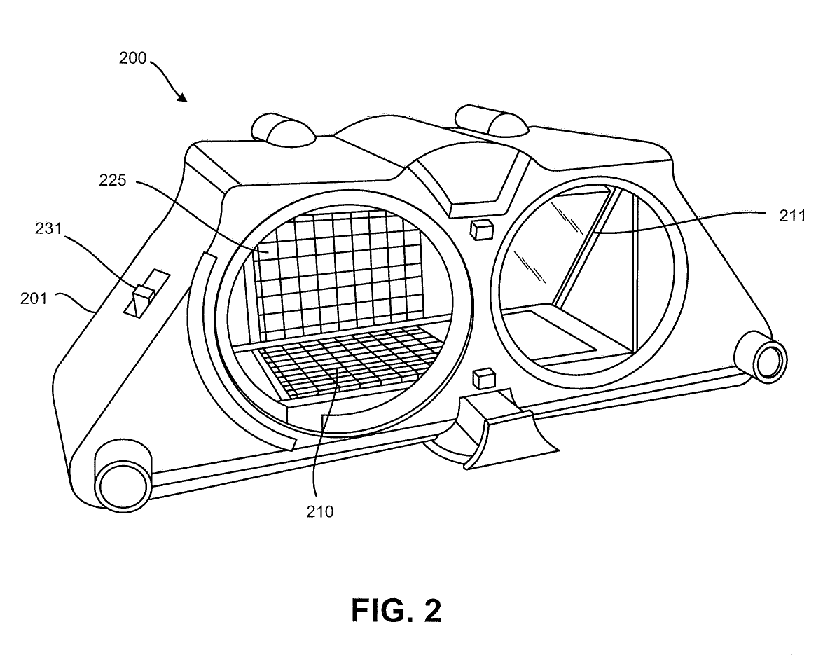

FIG. 2 illustrates a viewing side of a headset including an exemplary viewing device of the system of FIG. 1 with an exemplary computer-mediated reality device of the system of FIG. 1 plugged into the headset, according to one implementation of the present disclosure. Diagram 200 shows viewing device 201 having beam splitter 211, and user device 210, and displayed image 225. Viewing device 201 has a viewing side and a front side, where the viewing side faces the user and the front side faces the real world. Viewing device 201 may have one or more mechanical controls that may be operated by the user, such as switch 231. In some implementations, the one or more mechanical controls may include a button, a switch, a knob that can be turned, a mechanical slider, etc. In some implementations, the one or more mechanical controls may affect a corresponding one or more input elements. The one or more input elements provide input to user device 210.

Beam splitter 211 may be a device for transmitting at least a portion of the real-world image from the real-world port of viewing device 201 to viewing port 211 of viewing device 201. In some implementations, beam splitter 211 may be a dielectric mirror beam splitter, a beam splitter cube, a fiber optic beam splitter, etc. Beam splitter 211 may allow a portion of the light from the real world pass through beam splitter 211 and be presented to the user, and beam splitter 211 may reflect a portion of the light emitted by the display of user device 210 to be presented to the user. By transmitting a portion of the light from the real world and a portion of the light from the display of user device 210, the user of viewing device 201 may be presented with an augmented reality, where the display view of user device 210 augments the real world view presented to the user or viewer. In some implementations, viewing device 201 may be configured to not present any light from the real world to the user, in which case the user is presented with a virtual reality.

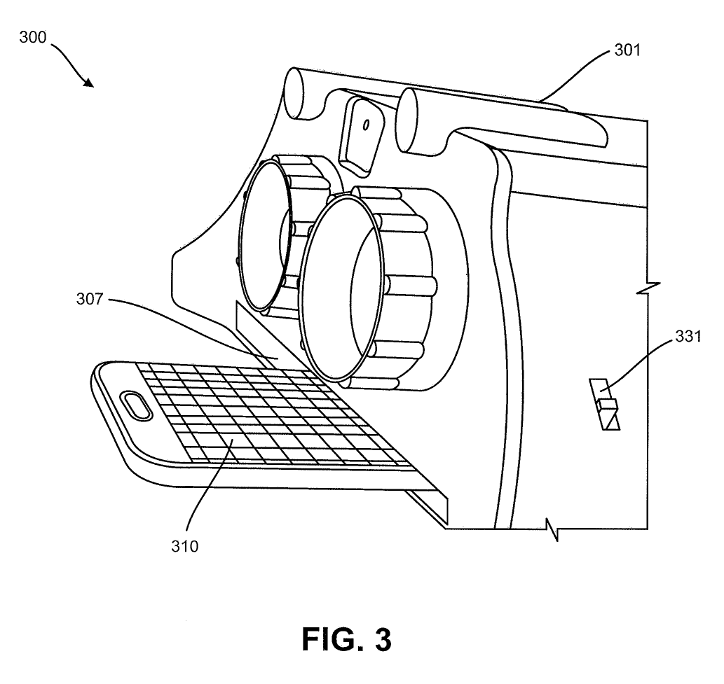

FIG. 3 illustrates a side view of the viewing device of FIG. 2, as viewing device 301 with computer-mediated reality device or user device 310 plugged therein, according to one implementation of the present disclosure. In some implementations, user device 310 may be oriented such that user device 310 is held within the body of viewing device 301. As shown in FIG. 3, receiving port 307 is below the viewing ports of viewing device 301. In some implementations, receiving port 307 may be located above the viewing ports, on a side of the viewing ports, etc. User device 310, when inserted into receiving port 307, may be positioned to not impede the line of sight through the viewing port of viewing device 301. Viewing device 301 may include one or more physical control devices, such as control element 331, for providing input to user device 310.

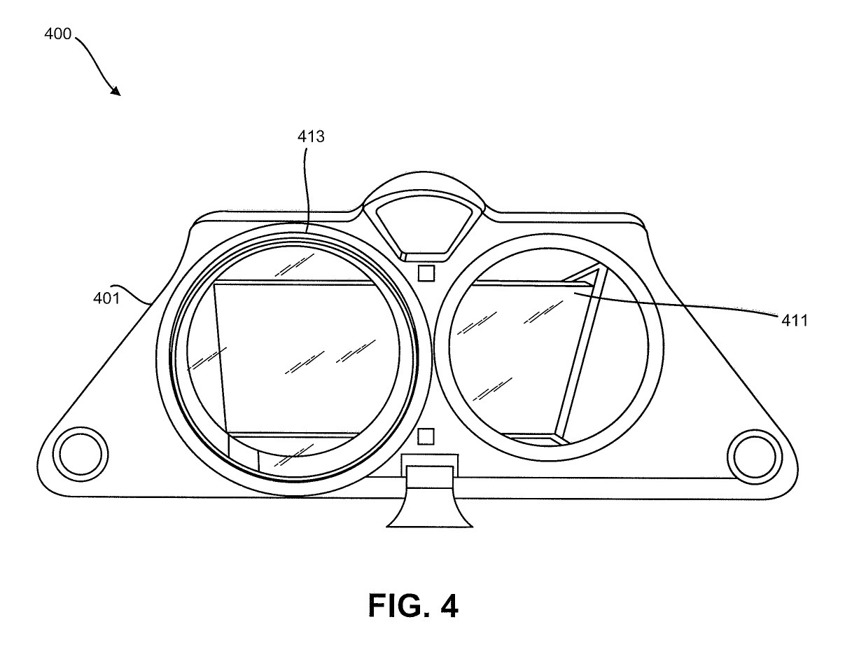

FIG. 4 illustrates a front view of the viewing device of FIG. 2 or viewing device 401, according to one implementation of the present disclosure. As shown in FIG. 4, in some implementations, the viewing port of viewing device 401may include a lens, such as lens 413. Lens 413 may include a dimming mechanism to reduce the real-world input passing through viewing portal 190 to the user. For example, lens 413 may have a first layer, and the first layer may have a polarization. Lens 413 may have a second layer, and the second layer may have a polarization. In some implementations, the first layer of lens 413 may be oriented in a first direction, and the second layer of lens 413 may be oriented in a second direction. When the first direction and the second direction are the same, i.e., the first polarization is parallel to the second polarization, at least a portion of the light from the real world may pass through lens 413 enabling the user to see the real world through viewing device 101, which may be augmented with virtual reality presented by the user device. When the first direction and the second direction are offset by an amount between 0° and 90°, the amount of light allowed to pass through lens 413 may decrease, as the angle increases from 0° to 90°, reducing the amount of real-world light visible to the user. When the first direction and the second direction are offset by about 90°, lens 413 may not allow any light to pass through, eliminating real-world input passing through lens 413. When lens 413 does not allow a real-world input, viewing device 101 may become a virtual reality viewing device.

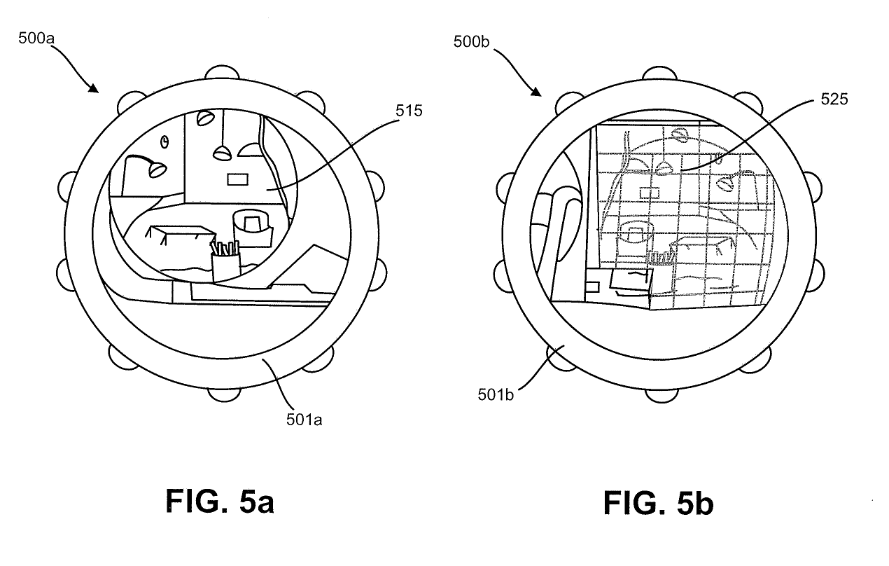

FIG. 5a illustrates an exemplary real-world scene presented by viewing device 201 of FIG. 2, according to one implementation of the present disclosure. Diagram 500a shows real-world scene 515 presented to the user through the viewing port of viewing device 501a without user device 210 having been inserted into the receiving port of viewing device 501a, or when the display of user device 210 is not activated. FIG. 5b illustrates an augmented-reality exemplary scene presented by viewing device 201 of FIG. 2 using user device 210, according to one implementation of the present disclosure.

FIG. 5b shows an exemplary augmented-world scene presented to the user through the viewing port of viewing device 501b with user device 210 having been inserted into the receiving port of viewing device 501b and activated. Diagram 500b shows augmented reality image 525 as a grid pattern superimposed over the real-world view visible by the user looking through the viewing port. In some implementations, a user may eliminate the real world view using lens 313, and create a virtual reality view only. In some implementations, user device 110 may switch from an augmented reality mode, as shown in FIG. 5b, to a virtual reality mode (not shown), in which user device 110 may render a virtual reality for the user to view. In some implementations, rotation of lens 313 by the user to block the real world view through the viewing port may provide input to user device 110, such that when the presentation of the real world input is reduced, user device 110 switches from an augmented reality mode to a virtual reality mode.

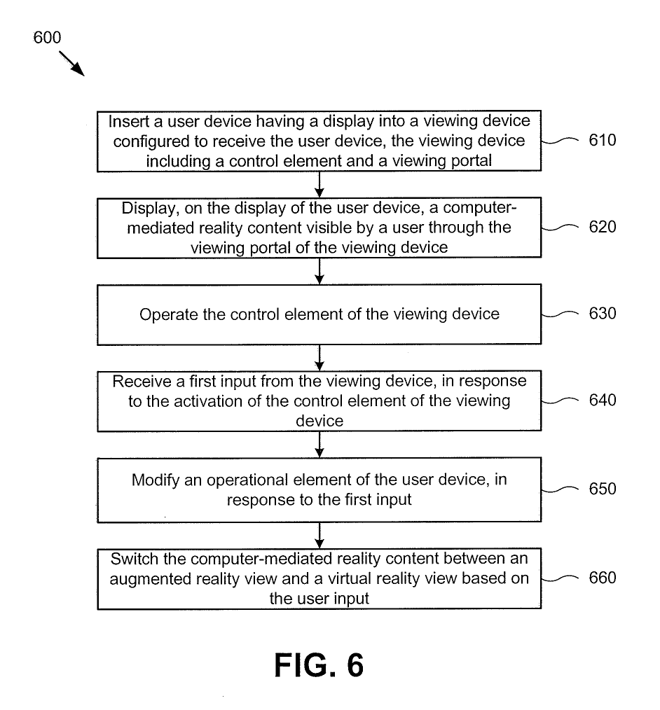

FIG. 6 illustrates a flowchart illustrating an exemplary method of providing input to the user device via the viewing device, according to one implementation of the present disclosure. Method 600 begins at 610, where a user inserts user device 110 into receiving port 107 of viewing device 101. In some implementations, user device 110 may be held in place using a pressure fitting, a friction setting, a connecting element, such as adhesive tape, Velcro, etc., or one or more straps holding user device 110 in place. User device 110 may be positioned such that display 160 is substantially parallel to the line of sight of the user looking through viewing portal 190. As such, display 160 may not be directly visible by the user. In other implementations, user device 110 may be inserted into receiving port 107 such that display 160 is substantially perpendicular to the line of sight of the user looking through viewing portal 190. In such an arrangement, display 160 may substantially fill the field of view of the user, and display 160 may show a real-world view captured using a camera of user device 110.

At 620, executable code 140 displays, on display 160 of user device 110, computer-mediated reality content 135, such that computer-mediated reality content 135 is visible by a user through viewing portal 190 of viewing device 101. In some implementations, display 160 may project computer-mediated reality content 135 onto beam splitter 111, allowing the user looking through viewing portal 190 to see computer-mediated reality content 135 superimposed on the view of the real world. In other implementations, the user may view display 160 and may directly view computer-mediated reality content 135. Computer-mediated reality content 135 may include an augmented reality content to be viewed with a real-world content, or computer-mediated reality content 135 may include a virtual reality content in which user device 110 renders a virtual reality.

At 630, the user operates control element 131 of viewing device 101. In some implementations, control element 131 may be a click wheel, such that each time the user rotates the click wheel, control element 131 makes an audible click. The click wheel may be configured such that subsequent clicks have different frequencies, allowing the frequency of the click to communicate a position in the rotation of control element 131. In other implementations, control element 131 may be a wheel including a plurality of sections each including a different visual content. The visual content may include a plurality of different patterns, a plurality of different colors, a plurality of shades of gray, etc.

In some implementations, control element 131 may include a mechanical component that contacts a portion of display 160, and operation of control element 131 may provide touch screen input to user device 110. Displaying computer-mediated reality content 135 may use less than all of display 160, such as about 80% of display 160, leaving about 20% of display 160 available to receive touch screen input without obstructing computer-mediated reality content 135. Control element 131 may be a button that may be operated to provide touch screen input, or a slider to provide a touch-and-slide input. Or control element 131 may be a rotatable knob connected to a worm gear, and operating control element 131 may provide a sliding touch screen input.

At 640, executable code 140 receives a first input from viewing device 101 using input device 150 in response to the activation of control element 131 of viewing device 101. Input device 150 may be an accelerometer. When the user operates control element 131, user device 110 moves in a certain way. The motion caused by operation of control element 131 may be received using the accelerometer, and the accelerometer may send an input signal to input module 143. In other implementations, input device 150 may be a camera. Control element 131 may be a disc or wheel divided into a plurality of sections, such as a plurality of radial sections, where each section may include a different visual pattern. The visual patterns may include different colors, different shades of gray, different graphic patterns, etc. When the user operates control element 131, different sections of the wheel may become visible to input device 150. The visual input caused by operation of control element 131 may be received using the camera, and the camera may send an input signal to input module 143.

In other implementations, input device 150 may be a microphone. Control element 131 may be a click-wheel configured to make an audible click when rotated. In some implementations, subsequent clicks created by operation of the click-wheel have substantially the same sound. In other implementations, subsequent clicks created by operation of the click-wheel may have different sounds, such as subsequent clicks that increase in pitch, decrease in pitch, etc. The clicks created by operation of control element 131 may be received using the microphone, and the microphone may send an input signal to input module 143, where different frequencies and audio sounds can be construed as different commands by processor 120. Input device 150 may be a magnetometer, a compass, or other device capable of receiving input as a result of operation of control element 150.

At 650, executable code 140 modifies an operational element of user device 110, in response to the first input. In some implementations, operational control module 141 may adjust a setting of user device 110, such as display on/off, volume, displayed content, camera on/off, etc. For example, operational control module 141 may increase the brightness of display 160 when a user operates an adjustable lens on viewing device 101 to make the real-world image presented through the lens brighter. In other implementations, operational control module 141 may make display 160 dimmer when the user operates the adjustable lens to dim the real-world view. Operational control module 141 may switch a viewing mode of user device 110 from an augmented reality viewing mode when the lens is adjusted to view the real world and computer-mediated reality content 135 at the same time to a virtual reality viewing mode when the lens is operated to block the real-world view. Operational control module 141 may switch a viewing mode of user device 110 from a virtual reality viewing mode when the lens is adjusted to block the real-world view to an augmented reality viewing mode when the lens is operated to view the real world and computer-mediated reality content 135 at the same time.

At 660, executable code 140 switches computer-mediated reality content 135 between an augmented reality view and a virtual reality view based on the user input. When control element 131 is operated to switch viewing device 101 from an augmented reality mode to a virtual reality mode by blocking the real world view through viewing portal 190, operational control module 141 may render a virtual reality in addition to the augmented reality content. Switching into the virtual reality view requires executable code 140 to render the virtual reality environment, which may be a virtual representation of the real-world environment, or may be a different virtual reality. In other implementations, the user input may switch viewing device 101 form a virtual reality mode to an augmented reality mode by adjusting the view through viewing portal 190 to allow the user to view the real world and computer-mediated reality content 135. Switching into augmented reality mode requires executable code 140 to cease rendering the virtual reality and operational control module 141 to adjust the brightness of display 160 for augmented reality viewing.

From the above description, it is manifest that various techniques can be used for implementing the concepts described in the present application without departing from the scope of those concepts. Moreover, while the concepts have been described with specific reference to certain implementations, a person having ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A computer-mediated reality system comprising:
a user device; and
a viewing device configured to receive the user device, the viewing device including a control element and a viewing portal;
the user device including:
a display;
a non-transitory memory storing an executable code;
a hardware processor executing the executable code to:
display, on the display, a computer-mediated reality content visible by a user through the viewing portal of the viewing device;
receive a first input from the viewing device, in response to a second input provided by the user using the control element of the viewing device;
modify an operational element of the user device, in response to the first input.

2. The computer-mediated reality system of claim 1, wherein modifying the operational element includes switching from one of an augmented reality view and a virtual reality view to the other.

3. The computer-mediated reality system of claim 2, wherein, when the user device is in the virtual reality view, the processor further executes the executable code to:
render a virtual reality.

4. The computer-mediated reality system of claim 1, wherein the first input is one of an audible sound, a color, a pattern, and a motion.

5. The computer-mediated reality system of claim 1, wherein the viewing device switches from one of an augmented reality mode to a virtual reality mode to the other using an adjustable lens.

6. The computer-mediated reality system of claim 5, wherein the adjustable lens includes a stationary polarized lens and a rotatable polarized lens.

7. The computer-mediated reality system of claim 1, wherein displaying the computer-mediated reality content includes projecting the computer-mediated reality content onto a beam splitter in the viewing portal of the viewing device.

8. The computer-mediated reality system of claim 1, wherein the control element is one of an accelerometer, a microphone, a camera, and a touch screen.

9. The computer-mediated reality system of claim 1, wherein modifying the operational element includes changing a brightness of the display.

10. The computer-mediated reality system of claim 1, wherein the second input includes a touch screen input entered on the display without obstructing the displaying of the computer-mediated reality content on the display.

11. A method for user with a computer-mediated reality system including a viewing device and a user device, the user device including a display, a non-transitory memory and a hardware processor, the method comprising:
displaying, using the display, a computer-mediated reality content visible by a user through a viewing portal of the viewing device;
receiving, using the hardware processor, a first input from the viewing device, in response to a second input provided by the user using the control element of the viewing device;
modifying, using the hardware processor, an operational element of the user device, in response to the first input.

12. The method of claim 11, wherein modifying the operational element includes switching from one of an augmented reality view and a virtual reality view to the other.

13. The method of claim 12, wherein, when the user device is in the virtual reality view, method further comprises:
rendering, using the hardware processor, a virtual reality.

14. The method of claim 11, wherein the first input is one of an audible sound, a color, a pattern, and a motion.

15. The method of claim 11, wherein the viewing device switches from one of an augmented reality mode to a virtual reality mode to the other using an adjustable lens.

16. The method of claim 15, wherein the adjustable lens includes a stationary polarized lens and a rotatable polarized lens.

17. The method of claim 11, wherein displaying the computer-mediated reality content includes projecting the computer-mediated reality content onto a beam splitter in the viewing portal of the viewing device.

18. The method of claim 11, wherein the control element is one of an accelerometer, a microphone, a camera, and a touch screen.

19. The method of claim 11, wherein modifying the operational element includes changing a brightness of the display.

20. The method of claim 11, wherein the second input includes a touch screen input entered on the display without obstructing the displaying of the computer-mediated reality content on the display.
